(19) United States
(12) Patent Application Publication
(10) Pub. No.: US 2026/0247462 A1
(43) Pub. Date: Aug. 20, 2026

(54) Master Node (MN) - Secondary Node (SN) Coordination for Session Change During Quality of Experience (QoE)/Radio Access Network Visible QoE (RVQoE) Measurements

(71) Applicant: Telefonaktiebolaget LM Ericsson (publ), Stockholm (SE)

(72) Inventors: Luca Lunardi, Genova (IT); Filip Barac, Huddinge (SE); Johan Rune, Lidingö (SE); Vengatanathan Krishnamoorthi, Linköping (SE); Cecilia Eklöf, Täby (SE)

(21) Appl. No.: 19/155,437

(22) PCT Filed: Feb. 16, 2024
(86) PCT No.: PCT/SE2024/050156

§ 371 Date: Aug. 11, 2025

Related U.S. Application Data
(60) Provisional application No. 63/446,136, filed on Feb. 16, 2023.

(51) Int. Cl. H04W 76/15; H04L 41/5067

(52) U.S. Cl. CPC H04W 76/15; H04L 41/5067

(57) ABSTRACT

Techniques configure Radio Access Network (RAN) nodes involved in the multi-connectivity operations of a User Equipment (UE) (24), such as a Master Node (MN) (20) and a Secondary Node (SN) (22), for example, to communicate with each other regarding the configuration of RAN Visible Quality of Experience (RV-QoE) measurements at the UE, or the modification of an existing RVQoE configuration at the UE, for an application session that is about to be delivered to the UE by one of the RAN nodes.

### TECHNICAL FIELD

The present disclosure relates generally to Quality of Experience (QoE) measurement reporting and, more particularly, to Radio Access Network (RAN) Visible QoE measurement reporting in multi-connectivity scenarios where the session data for an application session is delivered to a User Equipment (UE) via multiple RAN nodes.

### BACKGROUND

The Third Generation Partnership Project (3GPP) has specified Quality of Experience (QoE) measurements, also referred to as “application layer measurements,” for Long Term Evolution (LTE), Universal Mobile Telecommunications System (UMTS), and more recently for Fifth Generation (5G) New Radio (NR) in 3GPP Release 17 (Rel-17). The purpose of the QoE measurements is to measure the experience of the end user using certain applications. Currently, the QoE measurements are specified and supported for streaming services, such as mobile telephony services over the for Internet Protocol (IP) Multimedia Subsystem (IMS) services, and virtual reality (VR).

QoE Measurement Collection (QMC) enables the configuration of application layer measurements in the UE and transmission of QoE measurement result files, commonly referred to as QoE reports, to the network by means of Radio Resource Control (RRC) signaling. Reports with collected QoE reports are sent from the UE application layer to the UE Access Stratum (AS), which forwards them to the RAN. The RAN, in turn, forwards the reports transparently to a configured receiver, such as a Measurement Collection Entity (MCE), for example.

QoE measurements, and their reported results, are intended for analysis in the Operations and Management (OAM) system (or in other non-core network, non-RAN entities) and subsequent possible non-real-time optimizations. However, the RAN could also benefit from receiving measurement results of metrics measured or collected at the application layer. Such measurement results could, for example, complement the more radio related measurements, such as Reference Signal Receive Power (RSRP), Reference signal Received Quality (RSRQ), Signal to Interference Plus Noise Ratio (SINR). For instance, the RAN could use these measurement results for real-time or semi-real-time adaptations or optimizations of the treatment of an ongoing application session, e.g., in terms of scheduling priorities. For this reason, 3GPP introduced the so-called RAN Visible QoE (RVQoE) in Rel-17, which comprises periodic reporting of measured application layer metrics in a format that the RAN can understand.

Despite the introduction of RVQoE, however, a remaining challenge is how to configure User Equipment (UE) for RVQoE reporting in multi-connectivity scenarios where session data for an application session is delivered to the UE via multiple RAN nodes and how the measurement results are reported.

### SUMMARY

Embodiments of the present disclosure configure network nodes (e.g., the Master Node (MN) and the Secondary Node (SN)) involved in the multi-connectivity operations of a User Equipment (UE) to communicate with each other regarding the configuration of Radio Access Network (RAN) Visible Quality of Experience (QoE) (RVQoE) measurements at the UE, or the modification of an existing RVQoE configuration at the UE, for an application session that is about to be delivered by one or both of the network nodes.

A first aspect of the present disclosure provides a method, implemented at a first network node, for multi-connectivity operation for a User Equipment (UE) in a communications system comprising the first network node and a second network node. The first and second network nodes are involved in the multi-connectivity operation of the UE. In exemplary embodiments, the first network node determines that the second network node is to carry at least part of an application session for the UE. Responsive to the making the determination, the first network node sends an indication to the second network node that causes the second network node to configure Radio Access Network (RAN) Visible Quality of Experience (RV-QoE) information for the UE for the at least part of the application session.

A second aspect of the present disclosure provides a method, implemented at a second network node, for multi-connectivity operation for a User Equipment (UE) in a communications system comprising a first network node and the second network node. The first and second network nodes are involved in the multi-connectivity operation of the UE. In exemplary embodiments, the second network node receives an indication from the first network node to configure Radio Access Network (RAN) Visible Quality of Experience (RV-QoE) information for the UE for at least part of the application session. The second network node then sends a response message to the first network node that indicates whether the second network node will configure the RVQoE information for the UE.

A third aspect of the present disclosure provides a method, implemented at a User Equipment (UE) for multi-connectivity operation for the UE. The UE is in a communications system that comprises first and second network nodes. The first and second network nodes are involved in the multi-connectivity operation of the UE, and the UE is configured to send Radio Access Network (RAN) Visible Quality of Experience (RV-QoE) reports for an application session. In exemplary embodiments, the UE receives, from one of the first and second network nodes, RVQoE information that configures the UE to send an RVQoE report for the application session to the other of the first and second network nodes. The UE then obtains metrics for the application session according to the RVQoE information, and sends the RVQoE report, which includes the metrics, for the application session to the other of the first and second network nodes.

A fourth aspect of the present disclosure provides a first network node for multi-connectivity operation for a User Equipment (UE) in a communications system comprising the first network node and a second network node. The first and second network nodes are involved in the multi-connectivity operation of the UE. In exemplary embodiments, the first network node comprises processing circuitry and memory circuitry. The memory circuitry is configured to store instructions executable by the processing circuitry whereby the network node is configured to determine that the second network node is to carry at least part of an application session for a UE, and responsive to the determining, send an indication to the second network node causing the second network node to configure Radio Access Network (RAN) Visible Quality of Experience (RV-QoE) information for the UE for the at least part of the application session.

A fifth aspect of the present disclosure provides a first network node for multi-connectivity operation for a User Equipment (UE) in a communications system comprising the first network node and a second network node. The first and second network nodes are involved in the multi-connectivity operation of the UE. In exemplary embodiments, the first network node are configured to determine that the second network node is to carry at least part of an application session for a UE, and responsive to the determining, send an indication to the second network node causing the second network node to configure Radio Access Network (RAN) Visible Quality of Experience (RV-QoE) information for the UE for the at least part of the application session.

A sixth aspect of the present disclosure provides a computer program comprising instructions stored thereon that, when executed on processing circuitry of a first network node, cause the first network node to perform the method according to the first aspect.

A seventh aspect of the present disclosure provides a carrier containing the computer according to the sixth. The carrier is one of an electronic signal, optical signal, radio signal, or computer readable storage medium.

An eighth aspect of the present disclosure provides a non-transitory computer-readable storage medium comprising a computer program stored thereon. The computer program comprises executable instructions that, when executed by a processing circuit in a first network node, causes the first network node to perform the method according to the first aspect.

A ninth aspect of the present disclosure provides a second network node for multi-connectivity operation for a User Equipment (UE) in a communications system comprising a first network node and the second network node. The first and second network nodes are involved in the multi-connectivity operation of the UE. In exemplary embodiments, the second network node comprises processing circuitry and memory circuitry. The memory circuitry is configured to store instructions executable by the processing circuitry whereby the network node is configured to receive an indication from the first network node to configure Radio Access Network (RAN) Visible Quality of Experience (RV-QoE) information for the UE for at least part of the application session, and send a response message to the first network node, wherein the response message indicates whether the second network node will configure the RVQoE information for the UE.

A tenth aspect of the present disclosure provides a second network node for multi-connectivity operation for a User Equipment (UE) in a communications system comprising a first network node and a second network node. The first and second network nodes are involved in the multi-connectivity operation of the UE. In exemplary embodiments, the second network node is configured to receive an indication from the first network node to configure Radio Access Network (RAN) Visible Quality of Experience (RV-QoE) information for the UE for at least part of the application session, and send a response message to the first network node. The response message indicates whether the second network node will configure the RVQoE information for the UE.

An eleventh aspect of the present disclosure provides a computer program comprising instructions stored thereon that, when executed on processing circuitry of a second network node, causes the second network node to perform the method according to the second aspect.

A twelfth aspect of the present disclosure provides a carrier containing the computer program of the eleventh aspect. The carrier is one of an electronic signal, optical signal, radio signal, or computer readable storage medium.

A thirteenth aspect of the present disclosure provides a non-transitory computer-readable storage medium comprising a computer program stored thereon. In exemplary embodiments, the computer program comprises executable instructions that, when executed by a processing circuit in a second network node, causes the second network node to perform the method according to the second aspect.

A fourteenth aspect of the present disclosure provides a User Equipment (UE) in a communications system comprising first and second network nodes. The first and second network nodes are involved in a multi-connectivity operation of the UE, and the UE is configured to send Radio Access Network (RAN) Visible Quality of Experience (RV-QoE) reports for an application session. In exemplary embodiments, the UE comprises processing circuitry and memory circuitry. The memory circuitry configured to store instructions executable by the processing circuitry whereby the UE is configured to receive, from one of the first and second network nodes, RVQoE information that configures the UE to send an RVQoE report for the application session to the other of the first and second network nodes, obtain metrics for the application session according to the RVQoE information, and send the RVQoE report for the application session to the other of the first and second network nodes, wherein the RVQoE report includes the metrics.

A fifteenth aspect of the present disclosure provides a User Equipment (UE) in a communications system comprising first and second network nodes. The first and second network nodes are involved in a multi-connectivity operation of the UE, and the UE is configured to send Radio Access Network (RAN) Visible Quality of Experience (RV-QoE) reports for an application session. In exemplary embodiments, the UE is configured to receive, from one of the first and second network nodes, RVQoE information that configures the UE to send an RVQoE report for the application session to the other of the first and second network nodes, obtain metrics for the application session according to the RVQoE information, and send the RVQoE report for the application session to the other of the first and second network nodes, wherein the RVQoE report includes the metrics.

A sixteenth aspect of the present disclosure provides a computer program comprising instructions stored thereon that, when executed on processing circuitry of a User Equipment (UE), cause the UE to perform the method according to the third aspect.

A seventeenth aspect of the present disclosure provides a carrier containing the computer program of the sixteenth aspect. The carrier is one of an electronic signal, optical signal, radio signal, or computer readable storage medium.

An eighteenth aspect of the present disclosure provides a non-transitory computer-readable storage medium comprising a computer program stored thereon. The computer program comprises executable instructions that, when executed by a processing circuit in a User Equipment (UE), causes the UE to perform the method according to the third aspect.

### BRIEF DESCRIPTION OF THE DRAWINGS

FIG. 1 illustrates a wireless communication network supporting multi-connectivity where session data for an application session is delivered to a UE via multiple RAN nodes according to an embodiment of the present disclosure.

FIG. 2 illustrates a simplified message flow between a UE, a Master Node (MN), and a Secondary Node (SN) where the UE is configured to send RVQoE reports a RAN node according to an embodiment of the present disclosure.

FIG. 3 illustrates a simplified message flow between a UE, a MN, and a SN where the UE is configured to send RVQoE reports a RAN node according to an embodiment of the present disclosure.

FIG. 4 illustrates a simplified message flow between a UE, a MN, and a SN where the UE is configured to send RVQoE reports a RAN node according to an embodiment of the present disclosure.

FIG. 5 illustrates a simplified message flow between a UE, a MN, and a SN where the UE is reconfigured to send RVQoE reports a RAN node according to an embodiment of the present disclosure.

FIG. 6 illustrates a simplified message flow between two RAN nodes where one of the RAN nodes is configured to indicate a type of data carried by a sub-flow to the other RAN node according to an embodiment of the present disclosure.

FIG. 7 is a flow diagram illustrating an exemplary method, implemented at a first network node, for configuring a multi-connectivity operation of a User Equipment (UE) according to an embodiment of the present disclosure.

FIG. 8 is a flow diagram illustrating an exemplary method, implemented at a second network node, for configuring a multi-connectivity operation of a User Equipment (UE) according to an embodiment of the present disclosure.

FIG. 9 is a flow diagram illustrating an exemplary method, implemented at a User Equipment (UE), for configuring a multi-connectivity operation of the UE according to an embodiment of the present disclosure.

FIG. 10 illustrates an exemplary UE configured to perform RVQoE measurements per RAN node delivering session data to a UE.

FIG. 11 illustrates an exemplary network node configured to support RVQoE measurements reporting per RAN node delivering session data to a UE.

FIG. 12 shows an example of a communication system in accordance with some embodiments.

FIG. 13 is a block diagram of a host in accordance with various aspects described herein.

FIG. 14 shows a communication diagram of a host communicating via a network node with a UE over a partially wireless connection in accordance with some embodiments.

### DETAILED DESCRIPTION

The following terms are used throughout the specification. Particularly, the terms “UE”, “terminal equipment”, “wireless terminal” and “terminal” are used interchangeably, as are the terms “node”, “network node” and “RAN node.” The terms “application layer measurement configuration”, “application measurement configuration”, “RVQoE measurement configuration”, “RVQoE configuration”, “RVQoE measurement and reporting configuration” and “QoE Measurement Collection (QMC) configuration” are used interchangeably; however, the term “QMC configuration file” is not an equivalent term. Instead, the term “QMC configuration file” refers to the part of the SN configuration that comprises, for example, an XML file containing instructions of SN metrics to be collected.

Additionally, the network node reference throughout the disclosure can be a RAN node, a gNB, an eNB, an en-gNB, a ng-eNB, a gNB-CU, a gNB-CU-CP, a gNB-CU-UP, an eNB-CU, an eNB-CU-CP, an eNB-CU-UP, an IAB-node, an IAB-donor DU, an IAB-donor-CU, an IAB-DU, an IAB-MT, an O-CU, an O-CU-CP, an O-CU-UP, an O-DU, an O-RU, an O-eNB, a Non-Real Time RAN Intelligent Controller (Non-RT RIC), a Real-Time RAN Intelligent Controller (RT-RIC), an Operations, Administration, and Management (OAM) node, a Core Network (CN) node/function, a Cloud-based network function (NF), or a Cloud-based centralized training node.

Further, all references to the application layer are with respect to the application layer of the UE (since RAN nodes do not have an application layer). Additionally, the term “service” is often used herein as a short notation for the term “service type.” Therefore, the terms “service” and “service types” can be seen throughout the specification as interchangeable terms, unless explicitly stated.

The embodiments of the present disclosure apply to both signaling-based and management-based RVQoE measurements but may also optionally be restricted to apply to only one of them (i.e., signaling-based or management-based RVQoE measurements).

The terms “RVQoE report” and “RVQoE measurement report” are also used herein interchangeably, as are the terms “access stratum” and “radio layer” when referring to a UE. Additionally, the term “session” refers to an application session for which RVQoE measurement is applied.

Embodiments of the present disclosure also apply to Universal Mobile Telecommunications Service (UMTS), Long Term Evolution (LTE), and New Radio (NR), as well as future Radio Access Technologies (RATs) such as 6G. It should be noted here, though, that while the present disclosure is described in the context of management based QoE/RVQoE measurements, it is for illustrative purposes and ease of discussion only. Those of ordinary skill in the art should readily appreciate that the present embodiments are equally applicable to both management-based and signaling-based QoE/RVQoE measurements.

Additionally, the present embodiments are described in the context of an example of New Radio Dual Connectivity (NR-DC). However, the present disclosure can be generalized to Multi Radio Dual Connectivity (MR-DC) or to connectivity options with more than two RAN nodes as well (such as Evolved Universal Mobile Telecommunications Service Terrestrial Radio Access (E-UTRA) NR Dual Connectivity (EN-DC) and NR-E-UTRA Dual Connectivity (NE-DC).

The present embodiments also apply to carrier aggregation. Further, the terms information element (IE), field, and parameter are sometimes used interchangeably herein in the context of Abstract Notation One (ASN. 1). Parameters/IEs/fields used in ASN. 1 code as well as in procedural text in the 3GPP Radio Resource Control (RRC) specification for 5G/NR, i.e. 3GPP TS 38.331 version 17.3.0, are often named with a suffix indicating the number of the release of the 3GPP standard in which the parameter/IE/field was introduced in (e.g. the suffix “-r17” indicates a parameter/IE/field that was introduced in release 17 of the 3GPP standard). Additionally, parameters/IEs/fields following this naming convention are typically referred to herein both with and without the suffix. When the name including the suffix is used in the ASN. 1 code, it defines the formal name from the ASN. 1 compiler's perspective, while the name without the suffix is used in running text, e.g., in field descriptions and procedural text. In accordance with the present embodiments, both ways of referring to an IE/field/parameter may be used. Moreover, if/when these terms are used in the disclosure, they are used interchangeably.

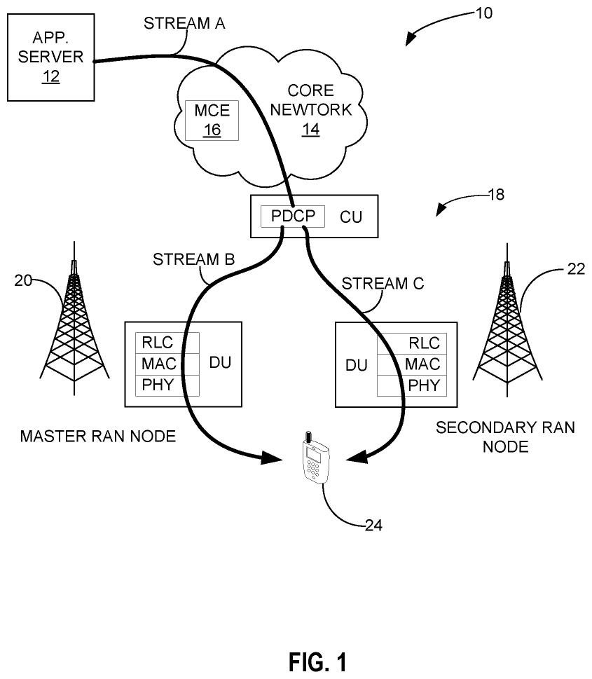

Turning now to the drawings, FIG. 1 illustrates a communication network 10 supporting multi-connectivity. The communication network includes a core network 14 and radio access network (RAN) 18. The core network 14 includes a Measurement Collection Entity (MCE) for collecting QoE and RVQoE measurements as herein described. The RAN 18 implements a split RAN architecture with a centralized unit (CU) serving two distributed units (DUs) located at respective RAN nodes: a master RAN node 20 (also referred to herein as a master node (MN)) and a secondary RAN node (also referred to herein as a secondary node (SN)). A RAN node may comprise any network node in the RAN, such as a 5G NodeB (e.g., gNB or gNodeB) including a Distributed Unit (DU) and Centralized Unit (CU), a DU, a CU, a radio unit, or a radio head.

An application server (AS) 12 generates session data for a user equipment (UE) 24, which is delivered over the communication network 10. The UE 24 may comprise any type of wireless device communicating with a RAN node and/or with another UE 24 in a wireless communication system. Examples of UEs 24 include cellular telephones, smart phones, tablets, notebooks, laptop computers, laptop mounted equipment (LME), vehicle-to-vehicle (V2V) communication devices, vehicle-to-everything (V2X) communication devices, machine type communication (MTC) devices, machine-to-machine M2M communication devices, and the like.

In the embodiment shown, a UE 24 in multi-connectivity is engaged in an end-to-end application session with AS 12 operated by a content service provider (CSP) (e.g., a video streaming session comprising an audio sub-stream and a video sub-stream). In this example, the wireless communication network 10 is used as a content delivery network to deliver the session data to the UE 24. The session data is delivered via a master RAN node 20 and secondary RAN node 22. Stream A represents the session data output by the AS 12 and is split in the RAN 18 into two streams, The first stream is denoted Stream B and is delivered by the master RAN node 20 (referred to hereinafter as MN 20). The second stream is denoted Stream C and is delivered by the secondary RAN node 22 (referred to hereinafter as SN 22). Some example scenarios where session data is delivered by multiple RAN nodes include:
Packet duplication scenarios, where identical session data is delivered to the UE 24 via both NR-DC legs. Duplication is usually applied for reliability reasons. In this case, Streams B and C are the same.
Situations where a session for an application contains different sub-flows/sub-streams (e.g., a video streaming session comprises an audio sub-stream and a video sub-stream). In some of these situations, some of the sub-flows/sub-streams are delivered via one network node (e.g., MN 20), and other sub-flows/sub-streams are delivered via another network node (e.g., SN 22)). In such cases, Streams B and C contain different sub-flows/sub-streams. In other situations, however, the sub-flows/sub-streams are delivered via both the network nodes (i.e., both MN 20 and SN 22) in an interleaved fashion. In these latter cases, Streams B and C contain different session data for the same sub-flows/sub-streams.
Situations where a session for an application contains only one flow comprised of multiple sub-flows that are inseparable at the network-level, where the flow/stream is split and delivered via both the network nodes MN 20 and SN 22. In these situations, Streams B and C contain different session data for the same flow.

Networks evaluate Quality of Service (QoS) by monitoring Key Performance Indicators (KPIs) which reflect network performance. However, KPIs don't necessarily correlate to end-user Quality of Experience (QoE). For example, a streaming service may meet certain performance criteria for the network but the customers' perceived QoE may vary depending on whether they're watching on a TV or a small mobile device. 3GPP has specified QoE measurements, also referred to as “application layer measurements,” to measure the experience of the end user using certain applications. Currently, the QoE measurements are specified and supported for Dynamic Adaptive Streaming over HTTP (Hypertext Transmission Protocol) (DASH) streaming, Mobility Telephony Service (MTS) for IMS (Internet Protocol Multimedia Subsystem) (MTSI) services, and virtual reality (VR).

To briefly explain, QoE Measurement Collection (QMC) enables the configuration of application layer measurements in the UE 24 and the transmission of QoE measurement result files, commonly referred to as “QoE reports”, to the network by means of Radio Resource Control (RRC) signaling. The RAN receives an application layer measurement configuration (also called QoE measurement configuration or QoE configuration) from the OAM system, or CN 14. The application layer measurement configuration is encapsulated in a transparent container, which is forwarded to UE 24 in a downlink RRCReconfiguration message. The UE Access Stratum or UE RRC layer receives an application layer measurement report (also called QoE report) from the UE's higher layer (application layer). The QoE report is encapsulated in a transparent container and sent to the network in an uplink RRC message, MeasurementAppLayerReport. The RAN then forwards the QoE report to a Measurement Collector Entity (MCE).

The 3GPP Rel-17 study titled “Study on NR QoE Management and Optimizations for Diverse Services,” which studied solutions for QoE measurements in NR, was finalized and concluded. According to this work item, not only will QoE management in NR collect the QoE parameters of streaming services, but it will also consider the typical performance requirements of diverse services such as augmented reality (AR), Virtual Reality (VR), and Ultra Reliable Low Latency Communications (URLLC). Of these services, at least VR was covered in 3GPP Rel-17. Based on requirements of these services, the NR study included more adaptive QoE management schemes that enable network optimization to satisfy user experience for diverse services.

The configuration data related to QoE measurements (in standard specifications typically referred to as application layer measurements) comprises a service type indication, an indication of an area in which the measurements are to be performed (denoted area scope), an Internet Protocol (IP) address of the entity to which the collected measurement results (i.e., the QoE reports) should be sent (often referred to as the MCE 16), and a set of instructions specifying the type of measurements that should be performed, as well as the details of how these measurements are to be performed. These instructions are intended for the application layer in the UE 24 and are placed in a “container” that cannot be read and interpreted by the network entities handling it (e.g., by forwarding it to the UE 24, as well as the UE 24 Access Stratum). The currently specified service types are MTSI, and the streaming service DASH. In 3GPP Rel-17, VR was added.

An “area scope” is defined in terms of cells or network related areas. For example, in UMTS, an area scope is defined as either a list of cells, a list of routing areas, or a list of tracking areas. In LTE, an area scope is defined as either a list of cells or a list of tracking areas. In NR, an area scope is defined as either a list of cells (e.g., a list of 5G NR Cell Global Identities (NCGIs)) or a list of tracking areas (e.g., a list of Tracking Area Codes (TACs)).

QoE, and in particular, the QoE configuration, comes in two flavors: management-based (m-based) QoE configurations and signaling-based (s-based) QoE configurations. In both cases, the QoE configuration originates in the OAM system or some other administrational entity, e.g., dealing with customer satisfaction. All of these entities are in this document referred to as the OAM system (where the OAM system also contains further entities).

With the m-based QoE, the OAM system is typically interested in general QoE statistics from a certain area, configured as an area scope. The m-based QoE configuration is sent directly from the OAM system to the RAN nodes controlling cells that are within the area scope. Each RAN node then selects the UEs that are within the area scope (and also fulfills any other relevant condition, such as supporting the concerned application/service type) and sends the m-based QoE configuration to these UEs.

With the s-based QoE, the OAM system is interested in collecting QoE measurement results from a specific UE 24, e.g., because the user of the UE 24 has filed a complaint. The OAM system sends the s-based QoE configuration to the Home Subscriber Server (HSS) in Evolved Packet System (EPS)/LTE) or Unified Data Management (UDM) (in a 5G System (5GS)/NR), which then forwards the QoE configuration to the UE's 24 current mobility management node in the CN 14 node (e.g. an Mobility Management Entity (MME) in EPS/LTE or an AMF in 5G/NR). The CN 14 then forwards the s-based QoE configuration to the RAN node that serves the concerned UE 24 and the RAN node forwards it to the UE 24.

Forwarded to the UE 24 are the service type indication and the container with the measurement instructions. The UE 24 is not aware whether a received QoE configuration is m-based or s-based. In legacy systems. The QoE framework is integrated with Trace functionality and a Trace Identifier (ID) is associated with each QoE configuration. In NR, the QoE functionality is logically separated from the Trace functionality, but it will still partly reuse the Trace signaling mechanisms. In NR, and possibly in LTE, a globally unique QoE reference will be associated with each QoE configuration. The QoE reference is formed by a Mobile Country Code (MCC)+Mobile Network Code (MNC)+QoE Measurement Collection (QMC) ID, where the QMC ID is a string of 24 bits. The QoE reference is included in the container with measurement instructions and sent to the RAN (i.e., the 5G NodeB (gNB) in NR). For the communication between the gNB and the UE 24, the QoE reference is replaced by a shorter identifier denoted as measConfigAppLayerId, which is locally unique within a UE 24 (i.e., there is a one-to-one mapping between a measConfigAppLayerId and a QoE reference for each QoE configuration provided to a UE 24. The measConfigAppLayerId is stored in the UE 24 Access Stratum and forwarded in an AT Command (which is the type of instructions used in the communication between the UE's modem part and the UE's application layer) together with the service type indication and the container with the measurement instructions.

Reports with collected QoE reports are sent from the UE 24 application layer to the UE 24 Access Stratum, which forwards them to the RAN. The RAN, in turn, forwards the QoE reports to the MCE. These QoE reports are placed in a “container,” which is uninterpretable for both the UE 24 Access Stratum and the RAN. QoE reporting can be configured to be periodic or only to be sent at the end of an application session. Further, the RAN can instruct the UE 24 to pause QoE reporting, e.g., in case the cell/gNB is in a state of overload.

Neither the RAN nor the UE 24 AS are automatically aware of when an application session with an associated QoE measurement session is ongoing. Thus, session “start”/“stop” indications are sent from the application layer in the UE 24 to the UE 24 AS and from the UE 24 AS to the RAN were introduced. A session “stop” indication may be explicit or may be implicit in the form of a QoE report sent when the application session and the associated QoE measurement session are concluded.

The RAN may decide to release a QoE configuration in a UE 24 at any time, as an implementation-based decision. Typically, this is done when the UE 24 has moved outside a configured area scope.

One opportunity provided by legacy solutions is the ability to retain the QoE measurement for the whole session, even during a handover situation. It is also contemplated to allow the UE 24 to continue with the QoE measurements on an ongoing application session until the application session ends, even if the UE 24 in the meantime moves out of the configured area scope.

As stated previously, QoE measurements, and their reported results, are intended for analysis in the OAM system (or in other entities that neither belong to the CN nor the RAN) and subsequent possible non-real-time optimizations. The QoE reports are forwarded transparently by the RAN to a configured receiver, such as an MCE, for example. However, the RAN could also benefit from receiving measurement results of metrics measured or collected at the application layer, e.g., as a complement to the more radio related measurements, i.e., the Radio Resource Management (RRM) measurements (e.g., Reference Signal Receive Power (RSRP), Reference signal Received Quality (RSRQ), Signal to Interference Plus Noise Ratio (SINR), etc.). For instance, the RAN could use such measurement results for real-time or semi-real-time adaptations or optimizations of the treatment of an ongoing application session, e.g., in terms of scheduling priorities.

For this reason, 3GPP introduced so-called RAN Visible QoE (RVQoE) in Rel-17, which comprises periodic reporting of measured application layer metrics in a format that the RAN can understand. These metrics, denoted as RVQoE metrics, are limited to QoE metrics in Rel-17. Example QoE metrics include the Buffer Level QoE metric for DASH (specified in 3GPP Technical Standard (TS) 26.247, version 17.1.0, which in turn references annex D.4.5 in ISO/IEC 23009-1, and represented in 3GPP TS 38.331 version 17.2.0 (i.e. the RRC specification) as the AppLayerBufferLevel-r17 field) and the Playout Delay for Media Start-up QoE metric for DASH (specified in 3GPP TS 26.247 version 17.1.0 and represented in 3GPP TS 38.331 version 17.2.0 (i.e. the RRC specification) as the playoutDelayForMedia Startup-r17 field). In addition to these two RVQoE metrics, a MeasurementReportAppLayer message may contain a PDU session ID list (in the form of the pdu-SessionIdList-r17 field) as part of the reported RVQ information (i.e., in the RAN-VisibleMeasurements-r17 Information Element (IE)).

The configurations for QoE and RVQoE are performed via an RRC reconfiguration message containing the AppLayerMeasConfig information element shown below. The configuration of legacy QoE metrics is done via the measConfigAppLayerContainer IE, which specifies the configuration to the application-layer in the UE 24 as an octet string (following Extensible Markup Language (XML)). RVQoE parameters are specified as part of the RAN-VisibleParameters IE.

-- ASN1START
-- TAG-APPLAYERMEASCONFIG-START
AppLayerMeasConfig-r17 ::= SEQUENCE {

| | |
|---|---|
| measConfigAppLayerToAddModList-r17 | SEQUENCE (SIZE (1..maxNrofAppLayerMeas- |
| r17)) OF MeasConfigAppLayer-r17 | OPTIONAL, -- Need N |
| measConfigAppLayerToReleaseList-r17 | SEQUENCE (SIZE (1..maxNrofAppLayerMeas- |
| r17)) OF MeasConfigAppLayerld-r17 | OPTIONAL, -- Need N |
| rrc-SegAllowed-r17 | ENUMERATED {enabled} OPTIONAL, -- Need R |
| . . . | |
| } | |

MeasConfigAppLayer-r17 ::= SEQUENCE {

| | |
|---|---|
| measConfigAppLayerld-r17 | MeasConfigAppLayerld-r17, |
| measConfigAppLayerContainer-r17 | OCTET STRING (SIZE (1..8000))OPTIONAL, -- |
| Need N | |
| serviceType-r17 | ENUMERATED {streaming, mtsi, vr, spare5, |
| spare4, spare3, spare2, spare1} | OPTIONAL, -- Need M |
| pauseReporting-r17 | BOOLEAN OPTIONAL, -- Need M |
| transmissionOfSessionStartStop-r17 | BOOLEAN OPTIONAL, -- Need M |
| ran-VisibleParameters-r17 | SetupRelease {RAN-VisibleParameters-r17} |
| OPTIONAL, -- Cond ServiceType | |
| . . . | |
| } | |

RAN-VisibleParameters-r17 ::= SEQUENCE {

| | |
|---|---|
| ran-VisiblePeriodicity-r17 | ENUMERATED {ms120, ms240, ms480, ms640, |
| ms1024} OPTIONAL, -- Need S | |
| numberOfBufferLevelEntries-r17 | INTEGER (1..8) OPTIONAL, -- Need R |
| reportPlayoutDelayForMediaStartup-r17 | BOOLEAN OPTIONAL, -- Need M |
| } | |

For Release 18 (Rel-18), the RAN3 Working Group is studying support for QoE and RVQoE measurements in NR-DC scenarios. In DC, the UE 24 connects to a MN and a SN, and switches the reporting leg based on an indication from network, which can be signaled implicitly or explicitly. In DC scenarios, both MN 20 and SN 22 can send a RVQoE configuration to the UE 24 and receive RVQoE reports directly from the UE 24. However, whether a MN 20 can modify a SN 22 generated RVQoE configuration has not yet been specified. In some scenarios, one node may configure QoE measurements for the UE 24 while the other node may receive the QoE reports and forward them directly to the MCE. In this scenario, the node that has configured the UE 24 with QoE measurements should indicate the QoE reference to the node that receives the reports and forwards them directly to MCE. In other scenarios, the UE 24 can send RVQoE reports to MN 20, which can forward the RVQoE report to SN 22 if needed, and vice versa.

In DC scenarios, configuring RVQoE measurements requires some coordination between MN 20 and SN 22. Configuration can be initiated by either MN 20 or SN 22 for m-based QoE, and by MN 20 for s-based QoE. The MN 20 and SN 22 need to coordinate to establish the Signaling Radio Bearers (SRBs) for receiving QoE/RV/QoE reports. In case of m-based QoE, MN 20 decides which node is to perform the QoE measurement configuration. When MN 20 configures a UE 24 with m-based QoE, it may indicate to the SN the QoE Reference, the MCE 16 IP address, and other relevant information. (e.g., RRC ID). In some embodiments, when SN 22 receives an m-based QoE measurement configuration, MN 20 should be aware that SN 22 has received the m-based QoE measurement configuration. In some embodiments, measures are taken to ensure that MN 20 is notified when SN 22 would like to configure an m-based QoE measurement. In some embodiments, SN 22 can send an RVQoE configuration to the UE 24 directly to UE 24 via SRB3 or via split SRB1. In other embodiments, SN 22 sends the RVQoE configuration over the Xn interface in scenarios where MN 20 can modify RVQoE.

Conventionally, executing QoE and/or RVQoE measurements requires coordination between the nodes involved in dual connectivity operations for a UE. Further, it is generally accepted that, for RVQoE measurements in NR-DC, the node that carries the session should generate the RVQoE measurement configuration and should also receive the RVQoE reports.

It is not entirely clear, though, how to ensure that conventional systems follow these principles in all scenarios. For example, consider a situation where MN 20 has already configured the UE 24 for RVQoE, and where the session is delivered via SN 22 for at least some of the time. In these cases, SN 22 may receive the RVQoE reports. However, since the RVQoE measurements are conventionally executed according to the RVQoE configuration prepared by MN 20, at least part of the RVQoE measurements collected may not be of interest to SN 22. Alternatively, SN 22 may want to receive a different set of RVQoE measurements and/or a different set of RVQoE measurements/metrics that correspond directly to the type of traffic being carried over SN 22.

In the reverse situation, i.e., where SN 22 has already configured the UE 24 for RVQoE and the session is delivered via MN 20 for at least some of the time-MN 20 may receive the RVQoE reports. However, because the RVQoE measurements in these situations are conventionally executed according to the RVQoE configuration prepared by SN 22, at least part of the RVQoE measurements collected may not be of interest for MN 20. Alternatively, MN 20 may want to receive a different set of RVQoE measurements and/or receive a different set of RVQoE measurements/metrics that correspond directly to the type of traffic being carried over MN 20.

Accordingly, embodiments of the present disclosure address such issues by configuring the network nodes involved in the multi-connectivity operations of a UE 24 (e.g., MN 20 and SN 22) to communicate with each other regarding the configuration of RVQoE measurements, or the modification of an existing RVQoE configuration, for an application session that is about to be delivered by one of the network nodes MN 20, SN 22 for some period of time. For example, consider a first network node (e.g., MN 20) and a second network node (e.g., SN 22), each of which is involved in the multi-connectivity operations of a UE 24. In some situations, the second network node may carry the application session while the application session is active only on the second network node. In other situations, the first and second network nodes may carry the application session in parallel with each other. Regardless, however, the present embodiments configure the first network node (e.g., MN 20) to indicate to the second network node (e.g., SN 22) that the second network node can configure the RVQoE measurements, or modify an existing RVQoE configuration, for that application session.

The present embodiments provide advantages and benefits that conventional systems do not or cannot provide. For example, in accordance with the present disclosure, a network node serving a UE in an application layer session is informed that it will carry at least part of the application session due, for example, to a leg switch (e.g., a switch of the path used to deliver the application session), and that it may be beneficial for that network node to configure RVQoE measurements for the UE. Because the identity of the particular node that will carry the session is not known a priori, the information provided to the network node helps ensure that the relevant node configures the RVQoE measurements.

In another advantage, the present embodiments can configure two network nodes (e.g., MN 20 and SN 22) to negotiate a new RVQoE reporting configuration for the UE. Additionally, the present embodiments communicate the RVQoE configuration change towards a new network node (e.g., the second network node) as part of the configuration change sent to the UE (e.g., in a RRC reconfiguration message from the first node). Such communication facilitates faster reporting commencement and simplifies signaling.

Another advantage may be realized in situations where two network nodes are serving the UE application as part of a dual connectivity configuration (e.g., when transitioning from a single connectivity to multi connectivity setup, or in response to a change of serving nodes within a multi connectivity setup). In these situations, the present embodiments advantageously configure and receive RVQoE feedback corresponding to the type of application data (or part thereof) that is carried by the network node (e.g., MN 20 may carry the video and SN 22 may carry the audio components of a DASH streaming session).

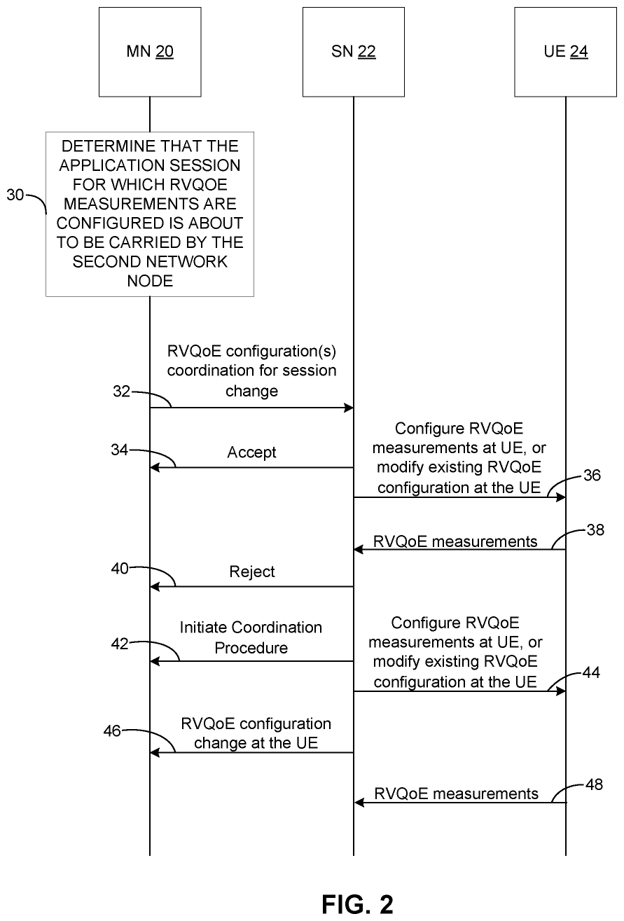

For example, in one embodiment, seen in FIG. 2, UE 24 is operating in multi-connectivity. That is, UE 24 is communicatively connected, via independent communication paths, to both MN 20 and SN 22, which may be the same or different types of nodes in the same or different networks. In this embodiment, data associated with an application session is initially delivered via only one of the RAN nodes (e.g., first network node functioning as a MN 20) and later delivered via another network node (e.g., second network node functioning as a SN 22) or via both MN 20 and SN 22. While not limiting, a typical case is where the data for an application session is first delivered only via MN 20, and following a leg switch for the bearer(s) carrying the application session, delivered only via SN 22.

In this embodiment, UE 24 is configured to operate in multi-connectivity towards MN 20 and SN 22. Further, MN 20 has already prepared a RVQoE configuration for, and sent the RVQoE configuration to, UE 24. The RVQoE configuration comprises RVQoE measurements for UE 24 to perform, and the application session for which the RVQoE measurements have been configured is either ongoing via MN 20 or not yet started.

As seen in FIG. 2, MN 20 determines that the application session for which RVQoE measurements are configured is about to be delivered via SN 22 (box 30). For example, MN 20 may determine that a switch of the path used to deliver the application session will occur (i.e., a leg switch). As another example, MN 20 may make the determination responsive to deciding to duplicate the delivery of the data associated with the application session. In the latter example, MN 20 may decide to deliver the data associated with the application session via both MN 20 and SN 22, or to configure a split bearer.

Regardless of the reason for making the determination, however, MN 20 sends one or more indications for RVQoE configuration(s) coordination for a session change in a message to SN 22, as will be described in more detail below (line 32). The one or more indications for RVQoE configuration(s) coordination provides SN 22 with information it will need to handle the RVQoE configuration(s). Upon receipt of the message, SN 22 can either accept or reject the suggested RVQoE configuration containing the indication(s). If SN 22 accepts the suggested RVQoE configuration (line 34), it may do so with or without providing an indication to MN 20 of its preferred configuration. Regardless, SN 22 can either configure the RVQoE measurements at the UE 24, or modify an existing RVQoE configuration at UE 24 (line 36) so that UE 24 will measure and provide information needed by SN 22 for the application session (line 38). If SN 22 rejects the suggested RVQoE configuration (line 40), it may do so with or without providing an indication of its preferred configuration.

In one embodiment, SN 22 can still decide a posteriori to accept receiving RVQoE measurement reports from UE 24 even after rejecting the suggested RVQoE configuration received from MN 20. In these situations, SN 22 can initiate a coordination procedure towards MN 20 (line 42), or it can configure UE 24 with a set of RVQoE measurements (line 44) and then inform MN 20 of the RVQoE configuration change at UE 24, accordingly (line 46). UE 24 would then send RVQoE measurement reports to SN 22 (line 48).

In a variant of this embodiment, MN 20 and SN 22 are operating in dual connectivity mode for UE 24, and SN 22 has configured UE 24 with RVQoE measurements for a specific service type. When UE 24 performs RVQoE measurements in accordance with the RVQoE measurement configuration, it sends the RVQoE reports to SN 22. Further, either no application of the specified service type is ongoing in UE 24 or an application session of the specified service type is ongoing in UE 24 and the data flow(s) of the application session is (are) carried by the connectivity leg to SN 22.

In one scenario of this embodiment, an application session is ongoing. The MN 20 determines that a switch of the connectivity leg for the application session's data flow(s) will occur or has occurred (i.e., a switch to the connectivity leg towards MN 20). The determination may be based on a decision by MN 20 to switch the application session's data flow(s) (e.g., the DRB(s) that carry the data flow(s)) to the connectivity leg towards MN 20. The MN 20 then sends a coordination message to SN 22, informing SN 22 that the connectivity leg for the application session's data flow(s) will be switched, or have been switched, and that MN 20 will take over the role as the receiver of the RVQoE reports from the UE 24.

In another scenario of this embodiment, MN 20 determines that an application session of the service type associated with the RVQoE configuration is beginning. This determination may, for example, be based on the reception of a session start indication from UE 24, or from SN 22 (i.e., forwarded from UE 24). Alternatively, or additionally, the determination may be based on packet inspection (e.g., detecting transport layer port numbers used by the application session) with the data flow(s) of the application session carried over the connectivity leg towards MN 20. The MN 20 could then determine to take over the role as the receiver of the RVQoE reports, and send a coordination message to SN 22, informing it that MN 20 will take over the role as the receiver of RVQoE reports (upon which SN 22, as one option, discards its stored version of the RVQoE measurement configuration it previously sent to the UE 24).

In both scenarios of this embodiment, SN 22 may send the RVQoE measurement configuration it previously sent to UE 24 to MN 20 (unless, for example, SN 22 did not previously send this RVQoE measurement configuration to MN 20). Additionally, MN 20 may or may not (re) configure UE 24 with a new RVQoE measurement configuration (e.g., a RVQoE measurement configuration that includes different metrics or specifies a different reporting periodicity than the RVQoE measurement configuration the UE had previously received from SN 22).

The MN 20 may also instruct UE 24 to send the RVQoE reports it generates to MN 20 (e.g., over the connectivity leg towards MN 20 or over a SRB configured towards MN 20). The instruction may be implicit (e.g., implied by the fact that MN 20 sends a RVQoE (re) configuration to the UE), or explicit (e.g., through (re) configuration of the SRB to send RVQoE reports on, for example, SRB4, SRB3 or SRB5), so that the RVQoE reports are sent to MN 20. In one embodiment, the instruction comprises an explicit indication, such as an MN/SN indication, or an identifier (e.g., a PCI) of the SpCell of the cell group (the MCG or the SCG) controlled by MN 20.

As stated above, the indications for RVQoE configuration(s) coordination for session change are carried in messages. Some examples of those messages include, but are not limited to:
An S-NODE MODIFICATION REQUEST XnAP message;
An S-NODE MODIFICATION REQUEST ACKNOWLEDGE XnAP message;
An S-NODE MODIFICATION REQUEST REJECT XnAP message;
An S-NODE RECONFIGURATION COMPLETE XnAP message;
An S-NODE MODIFICATION REQUIRED XnAP message;
An S-NODE MODIFICATION CONFIRM XnAP message;
An S-NODE MODIFICATION REFUSE XnAP message; and
A new XnAP message.

In another embodiment, UE 24 receives, during the application session or after being configured with a RVQoE configuration, but prior to the start of the application session, an indication from MN 20 to transmit the RVQoE reports to SN 22. The indication may, for example, be applicable for an already ongoing application session, and may be implicit (e.g., implied by the fact that the first network node sends a RVQoE (re) configuration to UE 24), or explicit (e.g., through (re) configuration of the SRB to send RVQoE reports on (e.g. SRB4, SRB3 or SRB5) so that the RVQoE reports are sent to MN 20. Additionally, or alternatively, the indication may be an explicit indication, such as an MN/SN indication or an identifier (e.g., a PCI) of an SpCell of the cell group (the MCG or the SCG) controlled by MN 20.

In another embodiment, UE 24 may receive, during the application session, an indication from MN 20 to transmit RVQoE reports to SN 22. In such embodiments, the RVQoE reports may comprise parameters that are different than those being sent by UE 24 to MN 20, and the indication to send RVQoE reports to SN 22 may be any of the previously described implicit or explicit indications.

The set of parameters (e.g., RVQoE measurement result parameters, RVQoE metrics) to be sent by UE 24 to SN 22 may be negotiated between MN 20 and SN 22 as part of the above-described RVQoE configuration(s) coordination messages. For example, MN 20 may inform SN 22 of the switch of the connectivity leg, and also that SN 22 will be the receiver of RVQoE reports from UE 24. In conjunction with informing SN 22 (e.g., in the same inter-node coordination message), MN 20 can request SN 22 to (re) configure RVQoE measurements for UE 24. In response to this request, SN 22 (re) configures RVQoE measurements for UE 24 and either transmits the RVQoE measurement (re) configuration to UE 24 or sends the RVQoE measurement (re) configuration to MN 20. In this latter case, MN 20 includes the RVQoE measurement (re) configuration received from SN 22 in the message sent to UE 24 with the indication to transmit the RVQoE reports to SN 22.

In one embodiment, there is a separate indication sent to UE 24 indicating whether a reconfiguration change is applicable directly for an already ongoing session.

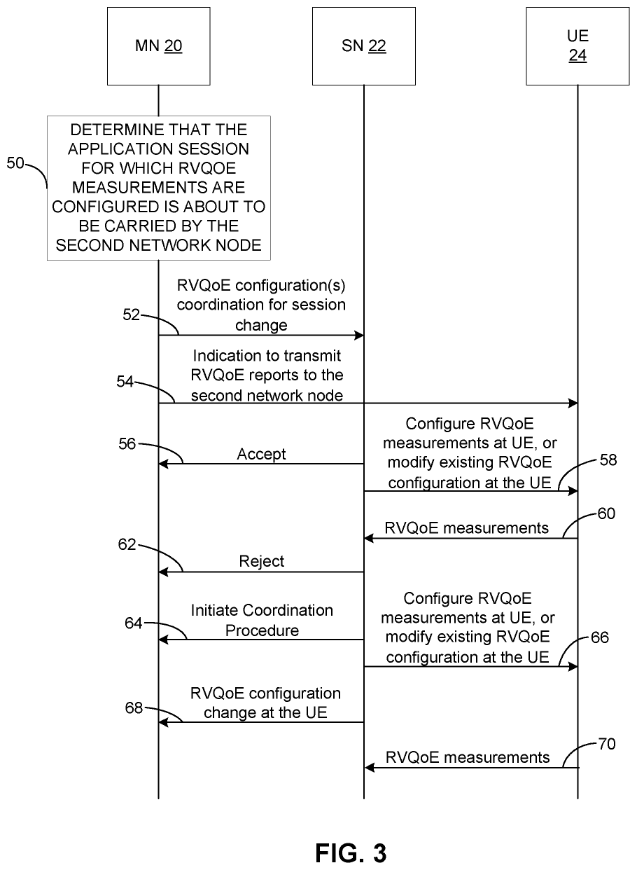

In another embodiment, seen in FIG. 3, UE 24 is initially operating in single connectivity mode but is later reconfigured to operate in a multi-connectivity mode (e.g., dual connectivity). In such cases, the data flow(s) associated with the application session are initially delivered to UE 24 via the only available network node (e.g., MN 20), and are later delivered via another network node (e.g., SN 22) added to the connection or via both network nodes. Typically, when the data flow(s) for an application session are first delivered via the only RAN node available (e.g., a gNB, functioning as an MN 20 in the multi-connectivity scenario), and after the addition of a second RAN node (e.g., the addition of another gNB functioning as an SN 22), the delivery of the session is switched from MN 20 to SN 22.

In the embodiment of FIG. 3, UE 24 is initially configured to operate in a single connectivity mode towards MN 20. At some point in time, SN 22 is added responsive, for example, to the execution of an SN Addition procedure. That is, UE 24 is reconfigured to operate in the multi-connectivity mode, which in this case, for the purposes of illustration, is a dual connectivity mode. Before SN 22 was added, however, MN 20 had already prepared and sent a RVQoE configuration to UE 24. Thus, the application session for which the RVQoE measurements were configured is ongoing via MN 20 at the time SN 22 was added, or alternatively, may not have started.

When SN 22 is added to the configuration, MN 20 determines that the session for the application for which RVQoE measurements was configured, is about to be delivered via the second network node (box 50). As above, this determination may be made by MN 20 responsive to determining that an upcoming leg switch, session duplication, or configuration of split bearer will occur. The MN 20 then provides one or more indications for RVQoE configuration coordination for session change to SN 22 (line 52). In one embodiment, the indications for RVQoE configuration coordination for session change can be carried in one of the following messages:
An S-NODE ADDITION REQUEST XnAP message
An S-NODE ADDITION REQUEST ACKNOWLEDGE XnAP message.
An S-NODE ADDITION REQUEST REJECT XnAP message
A new XnAP message

The UE 24 then receives, during the application session or after being configured, but prior to the start of the application session, an indication from MN 20 to transmit the RVQoE reports to SN 22 (line 54). The indication may, for example, be applicable for an already ongoing application session and may be of any of the forms described previously in connection with the embodiment of FIG. 2.

In one aspect of this embodiment, the RVQoE reports to be sent to SN 22 may comprise parameters that are different than those sent in the RVQoE reports to MN 20. Additionally, the indication to send the RVQoE reports to SN 22 may be any of the indications described later in more detail. Further, the set of parameters (e.g., RVQoE measurement result parameters, RVQoE metrics) to be sent by UE 24 to SN 22 may be negotiated between MN 20 and SN 22 as part of the RVQoE configuration(s) coordination messages.

As in the previous embodiment, there may be a separate indication towards UE 24 indicating whether a reconfiguration change is applicable directly for an already ongoing session.

In this embodiment, SN 22 can either accept or reject the suggested RVQoE configuration containing the indication(s). If the SN 22 accepts the suggested RVQoE configuration (line 56), it may do so with or without providing an indication to MN 20 of its preferred configuration. Regardless, however, SN 22 can either configure the RVQoE measurements at UE 24 or modify an existing RVQoE configuration at UE 24 (line 58) so that UE 24 will measure and provide information needed by SN 22 for the application session (line 60). If SN 22 rejects the suggested RVQoE configuration (line 62), it may do so with or without providing an indication of its preferred configuration.

In one embodiment, SN 22 can still decide a posteriori to accept receiving RVQoE measurement reports from UE 24 even after rejecting the suggested RVQoE configuration received from MN 20. In these situations, SN 22 can initiate a coordination procedure towards MN 20 (line 64), or it can configure UE 24 with a set of RVQoE measurements (line 66) and then inform MN 20 of the RVQoE configuration change at UE 24, accordingly (line 68). UE 24 would then send RVQoE measurement reports to SN 22 (line 70).

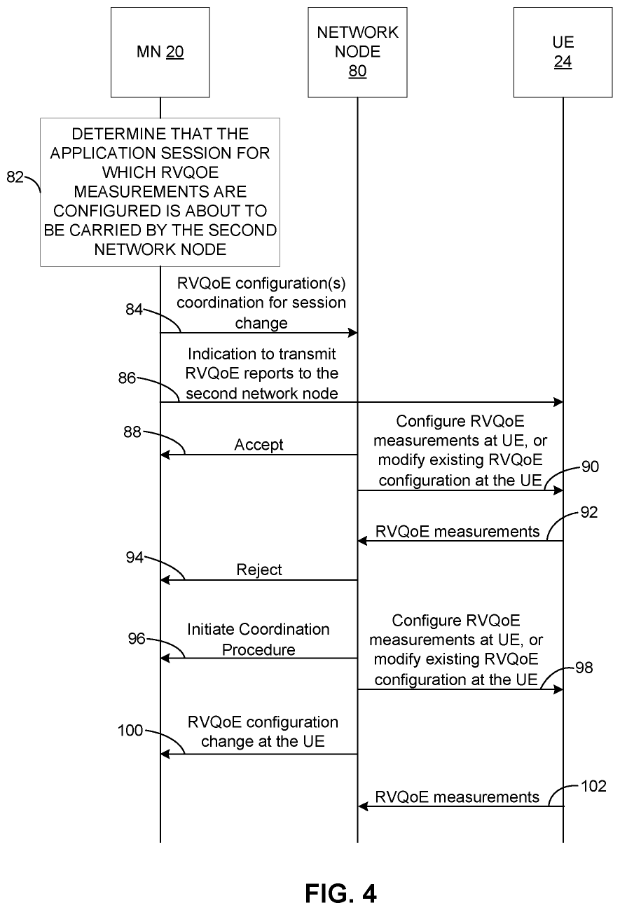

FIG. 4 is a signal diagram illustrating the signal flow of another embodiment of the present disclosure in which UE 24 is operating in a first multi-connectivity mode and then is reconfigured to operate in a different multi-connectivity mode with a leg switch, duplication, or split-bearer for the application session data flow. An example situation is where UE 24 is connected to MN 20 and SN 22 (e.g., a first MN and a first SN, respectively), and is then subsequently reconfigured to connect to MN 20 and a different network node functioning as a SN 22 (e.g., such as in the case of an MN/SN initiated SN change described in section 10.5 of 3GPP TS 37.340 v17.3.0, which is incorporated herein by reference in its entirety). Another example situation is where UE 24 will be connected to a different network node functioning as MN 20 with SN 22 functioning as an SN (e.g., such as in the case of an Inter-MN handover without SN Change described in section 10.7 of 3GPP TS 37.340 v17.3.0. Yet another example situation is where UE 24 will be connected to two new nodes—e.g., such as in a case where UE 24 connects to a network node functioning as a second MN 20 and another network node functioning as a second SN 22. Such situations may occur, for example, in the case of an Inter-MN handover with SN Change as described in section 10.7 of 3GPP TS 37.340 v17.3.0.

In this embodiment, UE 24 is initially configured to operate in multi-connectivity towards MN 20 (e.g., the source MN), and SN 22 (e.g., the source SN). Additionally, one of MN 20 and SN 22 has prepared a RVQoE configuration for UE 24 and sent the RVQoE configuration to UE 24.

In such embodiments, an application session for which the RVQoE measurements have been configured is ongoing via MN 20 (or, alternatively, the application session may not have started). In one aspect, MN 20 determines that the session for an application for which RVQoE measurements are configured is about to be delivered via a different network node 80 (box 82). In another aspect, MN 20 determines that the application session should be duplicated at the different network node 80. In yet another aspect, MN 20 can determine to configure a split bearer. However, in any of these aspects, the different network node 80 can be SN 22 previously described (i.e., the source SN), a target MN, or a target SN. In any of these aspects, however, MN 20 provides one or more indications for RVQoE configuration coordination for session change to the different network node 80 (line 84).

Alternatively, in such embodiments, the application session for which the RVQoE measurements have been configured is ongoing via SN 22. As above, MN 20 may determine that the application session for which RVQoE measurements are configured is about to be delivered via another network node (or, alternatively, the application session may not have started). Alternatively, MN 20 may determine that the application session is to be duplicated or determine to configure a split bearer. In this embodiment, the different network node 80 can be MN 20 functioning as the source MN, or another network node functioning, for example, as a second target MN 20 or as a second target SN 22. Regardless, SN 22 then provides (potentially via MN 20) one or more of indications for RVQoE configuration coordination for session change to the other network node.

The indications for RVQoE configuration coordination for session change will be described in more detail later. However, in some aspects, the indications for RVQoE configuration(s) coordination for session change can be carried in one of the following messages:
An S-NODE CHANGE REQUIRED XnAP message;
An S-NODE CHANGE CONFIRM XnAP message;
An S-NODE CHANGE REFUSE XnAP message;
An HANDOVER REQUEST XnAP message;
An HANDOVER REQUEST ACKNOWLEDGE XnAP message;
An S-NODE ADDITION REQUEST XnAP message;
An S-NODE ADDITION REQUEST ACKNOWLEDGE XnAP message;
An S-NODE ADDITION REQUEST REJECT XnAP message;
An S-NODE RECONFIGURATION COMPLETE XnAP message;
An S-NODE RELEASE REQUEST XnAP message;
An S-NODE RELEASE REQUEST ACKNOWLEDGE XnAP message;
An S-NODE RELEASE REQUEST REJECT XnAP message; and
A new XnAP message.

In one aspect, UE 24 receives (i.e., during the application session, or after being configured but prior to the start of the application session) an indication from MN 20 to transmit the RVQoE reports to the other network node 80 (line 86). The indication, which may be any of the indications explained later in more detail, may be applicable for an already ongoing session.

In an extension of the above realization, UE 24 may receive during the application session an indication from MN 20 to transmit RVQoE reports to SN 22. In these cases, the parameters for the RVQoE reports sent to SN 22 may be different than those reported to MN 20. Indicating that SN 22 is to be the receiver of the RVQoE reports may be implemented using any of the indications that are described later more fully. Additionally, the set of parameters (e.g., RVQoE measurement result parameters, RVQoE metrics) to be sent by UE 24 to SN 22 may be negotiated between MN 20 and SN 22 as part of the previously described coordination messages.

As above, there may be a separate indication towards UE 24 indicating whether a reconfiguration change is applicable directly for an already ongoing session.

In this embodiment, the other network node 80 can either accept or reject the suggested RVQoE configuration containing the indication(s). If the other network node 80 accepts the suggested RVQoE configuration (line 88), it may do so with or without providing an indication to MN 20 of its preferred configuration. Regardless, the other network node 80 can either configure the RVQoE measurements at the UE, or modify an existing RVQoE configuration at UE 24 (line 90) so that UE 24 will measure and provide information needed by the other network node 80 for the application session (line 92). If the other network node 80 rejects the suggested RVQoE configuration (line 94), it may do so with or without providing an indication of its preferred configuration.

In one embodiment, the other network node 80 can still decide a posteriori to accept receiving RVQoE measurement reports from UE 24 even after rejecting the suggested RVQoE configuration received from MN 20. In these situations, the other network node 80 can initiate a coordination procedure towards MN 20 (line 96), or it can configure UE 24 with a set of RVQoE measurements (line 98) and then inform MN 20 of the RVQoE configuration change at UE 24, accordingly (line 100). UE 24 would then send RVQoE measurement reports to network node 80 (line 102).

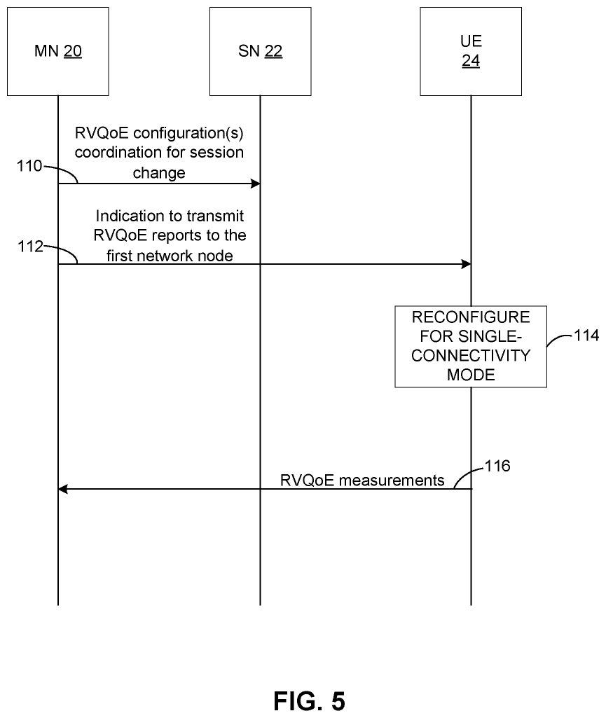

FIG. 5 is a signal diagram illustrating another embodiment of the present disclosure in which UE 24 initially operates in a multi-connectivity mode but is subsequently reconfigured to operate in a single connectivity mode.

In this embodiment, UE 24 is initially configured to operate in a multi-connectivity mode towards MN 20 functioning in the role of a MN, and SN 22 functioning in the role of a SN. In this embodiment, SN 22 has prepared and sent a RVQoE configuration to UE 24. An application session for which the RVQoE measurements have been configured is ongoing via SN 22;

however, in one possible alternate scenario, the application session may not have started. In such cases, the present embodiments can reconfigure UE 24 to change from operating in the multi-connectivity mode to operating in the single connectivity mode, after which data flow(s) associated with the application session is switched to MN 20.

In more detail, this embodiment calls for MN 20 to provide one or more indications for RVQoE configuration coordination for session change to SN 22 (line 110) (alternatively, SN 22 may provide the one or more indications for RVQoE configuration coordination for session change to MN 20). For example, MN 20 can indicate whether an application session that is currently ongoing at SN 22 can continue at MN 20 or will be interrupted. Such indications are described below in more detail; however, in at least one aspect, the indications for RVQoE configuration(s) coordination for session change can be carried in one of the following messages:
An S-NODE RELEASE REQUEST XnAP message;
An S-NODE RELEASE REQUEST ACKNOWLEDGE XnAP message;
An S-NODE RELEASE REQUEST REJECT XnAP message;
An S-NODE RELEASE REQUIRED XnAP message;
An S-NODE RELEASE CONFIRM XnAP message; and
A new XnAP message

During the application session, UE 24 may receive an indication from MN 20 to transmit RVQoE reports to SN 22 (line 112). The set of parameters (e.g. RVQoE measurement result parameters, RVQoE metrics) to be sent by UE 24 to SN 22 may comprise parameters that are different than those in the RVQoE reports sent to MN 20, and may be negotiated between MN 20 and SN 22 as part of the above-described RVQoE configuration(s) coordination messages. Once received, UE 24 reconfigures the single connectivity mode (box 114) and sends the RVQoE measurements to MN 20 (line 116).

As stated previously, there may be a separate indication towards the UE 24 indicating whether a reconfiguration change is applicable directly for an already ongoing session.

It should be noted here that the embodiments described herein are also applicable to services such as DASH and VR, as well as other generalized traffic (e.g., web traffic). With such services, it is possible that the application session data flow(s) comprise multiple sub-flows. Such sub-flows are independent from the perspective of the transport. By way of example, the application session data flow(s) associated with DASH services may be split into audio and video data, which are independently requested by UE 24 over HTTP. The RAN may infer the different sub-flows of the application session via a shallow inspection performed on the packet headers in the user plane. Additionally, the RAN may infer the different sub-flows of the application session by computing the volume of data transferred over each of these connections to identify which of the links carries the video data and which of the links carries the audio data. The RAN may also obtain this information explicitly via the CN 14 about the independent sub-flows in a DRB during the setup of the data forwarding tunnels in the user plane.

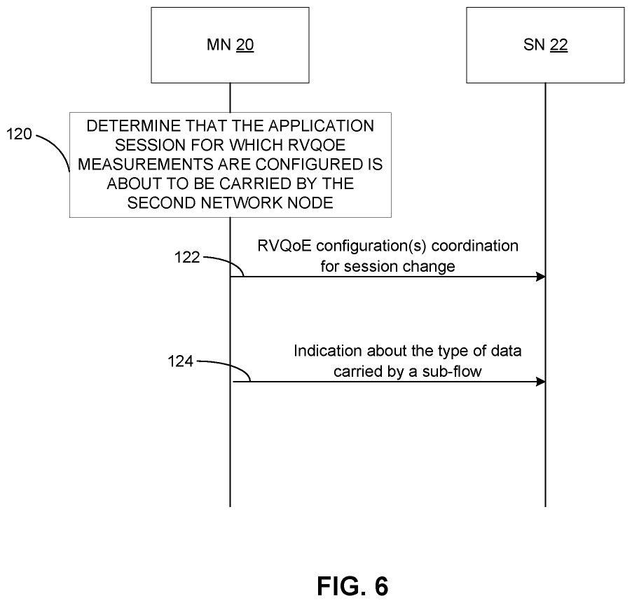

FIG. 6 illustrates a simplified message flow between two RAN nodes (e.g., MN 20 and SN 22) where one of the RAN nodes is configured to indicate a type of data carried by a sub-flow to the other RAN node according to an embodiment of the present disclosure. As seen in FIG. 6, during any of the above-described reconfigurations, and with access to the above information, MN 20 and SN 22 can determine that the application session and the corresponding sub-flows for which RVQoE measurements were configured is about to be delivered via the other of MN 20 and SN 22 (box 120). In such cases, MN 20 provides to SN 22 (or vice versa) the one or more indications for RVQoE configuration coordination for session change (line 122). Additionally, MN 20 may provide to SN 22 (or vice versa) one or more indications about the type of data carried over the sub-flow (line 124).

As stated above, the network nodes (i.e., MN 20 and SN 22) may send indications for RVQoE configuration coordination for session change. The following indications are valid for cases of “ongoing sessions,” (i.e., where an application session has started and the associated data flow(s) are being delivered to UE 24), as well as for application sessions in which the associated data flow(s) have not yet been delivered.

Indication for RVQoE configuration(s) coordination for an ongoing application session provides the network node receiving the indication with information concerning the handling of RVQoE configuration(s). In at least one embodiment, the indication may comprise one or more of the following:
An indication that a first network node/second network node (i.e., MN 20, SN 22) has configured QoE and/or RVQoE measurements for the UE;
An indication (e.g., an identifier) of the RVQoE configuration (e.g., a “QoE reference” or a “MeasConfigAppLayerId”) with which the first network node/second network node (i.e., MN 20, SN 22) configured, or plan to configure, the UE;
An indication that the application session for the UE will be carried by the first network node/second network node;
An indication that the application session for the UE will not be carried by the first network node/second network node. In embodiments where the UE is reconfigured to operate from a dual connectivity mode to a single connectivity mode, this indicates that the delivery of the application session data flow(s) will be stopped;
An indication of the proposed RVQoE configuration to be used by the second node/first network node;
An indication that the application session for the UE will be carried by both the first and second network nodes, and optionally, an indication of which part of the data flow, or which sub-flow(s), will be carried via which node (e.g., which network node will carry voice, which network node will carry audio, etc.);
An indication that the session is ongoing or that the UE has been configured, but the application session has not started yet;
An indication that the UE will transmit RVQoE reports to the second network node/first network node;
A request, or offer, to the other network node to provide an RVQoE (re) configuration to the UE, which is to be sent directly to the UE from the other network node, or via the requesting/offering network node (to be further elaborated below);
An indication to the receiving network node that the data flow(s) of an ongoing application session is about to be delivered (or will be delivered) via the receiving network node (the indication can be implicit or explicit);
   This indication is valid, for example, in cases of SN Addition, SN Change, SN Modification, Conditional SN Addition, Conditional SN Change, or Inter-MN handover with/without SN Change;
an indication to the receiving network node that the delivery of the data flow(s) of an ongoing application session via the receiving network node is about to be interrupted (the indication can be implicit or explicit);
   This indication is valid, for example, in cases of SN Release;
A notification to the receiving network node that the second network node is allowed to/should/can/may (or is not allowed/should not/cannot/may not) configure a new RVQoE configuration for the UE for collecting RVQoE reports associated with the session for the application whose delivery is being switched towards the receiving network node;
   In one embodiment, the possibility to configure a new RVQoE configuration depends on whether the maximum number of RVQoE configuration with which a UE can be configured is reached;
   In another variation, the notification includes information of the available RVQoE metrics (i.e., the RVQoE metrics that are available for RVQoE measurement and reporting, and thus for RVQoE configuration);
   In another embodiment, the receiving network node can be added as a network node for the delivery of the data flow(s) associated with the application session for the application (for instance, when data for a session are duplicated and sent/received both via MN 20 and SN 22).
A notification to the receiving network node that the second network node is allowed to/should/can/may (or is not allowed to/should not/cannot/may not) modify an existing RVQoE configuration for the UE for collecting RVQoE reports associated to the application session whose delivery is being switched towards the receiving network node;
   In one aspect, the possibility of modifying an existing RVQoE configuration depends on whether the reporting periodicity can be changed;
   In one aspect, the notification includes information of the available RVQoE metrics (i.e. the RVQoE metrics that are available for RVQoE measurement and reporting, and thus for RVQoE configuration);
A notification to the receiving network node that the receiving network node is allowed to/should/can/may (or is not allowed to/should not/cannot/may not) replace/override an existing RVQoE configuration for the UE for collecting RVQoE reports associated with the application session whose delivery is being switched towards the receiving network node;
   In one aspect, the possibility to replace/override an existing RVQoE configuration depends on whether the reporting periodicity can be changed;
   In aspect, the notification includes information of the available RVQoE metrics (i.e. the RVQoE metrics that are available for RVQoE measurement and reporting, and thus for RVQoE configuration;
An indication of one or more parameters comprised in the RVQoE configuration that the receiving network node is allowed to/should/can/may (or is not allowed to/should not/cannot/may not) modify (or replace, or remove, or override), and how the parameters can be modified (or replaced, or removed, or overridden);
   As an example, the MN (e.g., the first network node) can indicate to the SN (e.g., the second network node) whether it can add one or more RVQoE metrics to the existing RVQoE metrics, and/or whether it can modify the reporting periodicity;
A notification to the receiving node on the suggested parameters it should/may/can (or should not/cannot/may not) use for the new RVQoE configuration for the UE for collecting RVQoE reports associated to the session for the application whose delivery is being switched towards the receiving network node;
A notification to the receiving network node that a RVQoE configuration has been sent to the UE to collect RVQoE reports associated to the application's session;
A notification to the receiving network node that RVQoE measurements are ongoing in relation to the session for the application that is about to be (or will be) delivered via the receiving network node;
An indication of the parameters concerning the RVQoE configuration(s) sent to the UE;
   Non-limiting examples include: measConfigAppLayerId(s), the reporting periodicity, whether reporting of RVQoE metrics can be requested upon triggering of an event (e.g., when a radio related event is fulfilled), whether alignment between RVQoE measurements and radio measurements (e.g., MDT measurements) is ongoing or should be activated/enabled/started/resumed, or deactivated/disabled/stopped/paused.

The indications above used in network signaling may be used in a preparation phase in the network, before transmitting a reconfiguration message to UE 24. The reconfiguration message to UE 24 may comprise reconfiguring the UE's RVQoE configuration, indicating that RVQoE reports shall be sent to another network node, and/or indicating that a reconfiguration shall be applied directly for an ongoing session etc.

In case the network nodes are split gNBs (i.e., the network nodes consist of a gNB-CU-CP, gNB-DUs, and gNB-CU-CPs), then the roles of first, second, third, and fourth network nodes may be performed by the gNB-DU parts of these nodes, or by the gNB-CU-CP parts of these nodes. In this case, the coordination messages originate from the gNB-DUs (or the gNB-CUs), and are passed via their respective gNB-CUs to other network nodes.

The same applies for the CP-UP split architecture, where the gNB-CU-UP may play a role of a network node, and the messages are passed via their respective gNB-CU-CPs to other network nodes.

It should be noted that throughout the disclosure, MN 20 is described as being the MN while SN 22 is described as being the SN. However, this is for illustrative purposes and ease of discussion only. Those skilled in the art should readily understand that the present disclosure is not so limited, and that MN 20 can be the SN and SN 22 can be the MN in any of the embodiments.

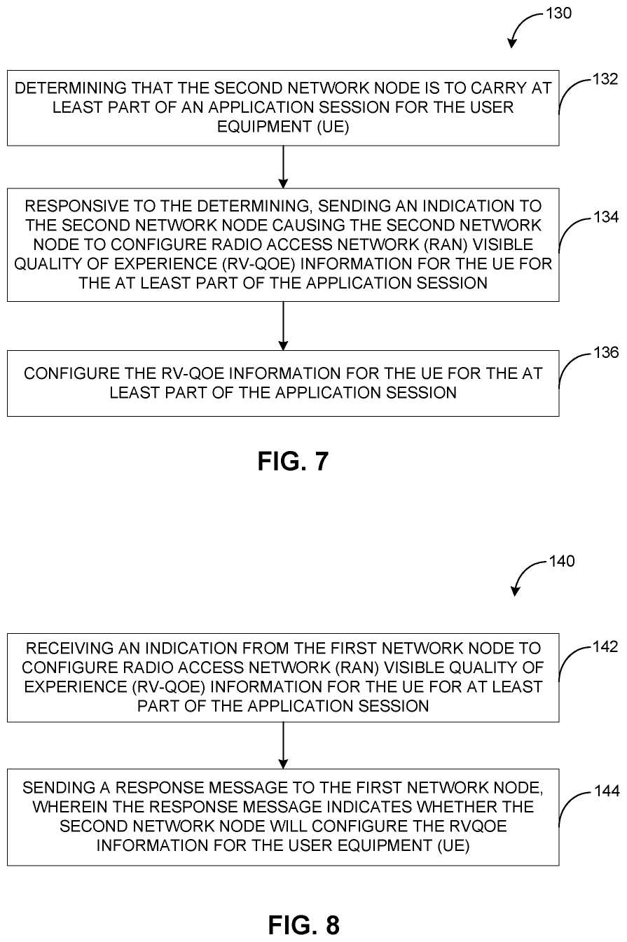

FIG. 7 is a flow chart illustrating a method 130 for multi-connectivity operation for a User Equipment (UE) in a communications system comprising first and second network nodes. In this embodiment, the first and second network nodes (i.e., MN 20 and SN 22) are involved in the multi-connectivity operation of the UE, and the method 130 is implemented at the first network node.

As seen in method 130, the first network node (i.e., MN 20) determines that the second network node (i.e., SN 22) is to carry at least part of an application session for the UE (box 132). Responsive to making the determination, the first network node sends an indication to the second network node. The indication causes the second network node to configure Radio Access Network (RAN) Visible Quality of Experience (RV-QoE) information for the UE for the at least part of the application session (box 134).

In one embodiment, the first network node determines that the application session for which the RVQoE measurements are configured will be carried by the second network node.

Additionally, in one embodiment, the first network node may determine that the second network node is to carry at least part of an application session for the UE is based on a switch of the path used to deliver a data flow of the application session.

In one embodiment, the first network node may determine that the second network node is to carry at least part of an application session for the UE is based on a decision to duplicate a data flow of the application session. In these cases, the duplicate data flow of the application session may be delivered to the UE via both the first network node and the second network node.

In another embodiment, the first network node may determine that the second network node is to carry at least part of an application session for the UE is based on a decision to configure a split bearer.

In some embodiments, the first network node sends one or more indications for RVQoE configuration coordination to the second network node. In such embodiments, the first network node sends an indication to transmit RVQoE reports to the second network node.

In one embodiment, the first network node receives an acknowledgement from the second network node responsive to the one or more indications for RVQoE configuration coordination.

In another embodiment, the first network node receives a rejection from the second network node responsive to the one or more indications for RVQoE configuration coordination. In these embodiments, the first network node may or may not receive an indication of a preferred RVQoE configuration for the second network node with the rejection.

In one embodiment, after receiving the rejection from the second network node, the first network node receives an Initiate Coordination Procedure message from the second network node to begin receiving RVQoE reports from the UE.

In one embodiment, the first network node receives, from the second network node, an indication of a change in a RVQoE configuration of the UE.

In at least one embodiment, the first network node receives RVQoE reports from the UE.

In one embodiment, the first network node sends an indication to the second network node that identifies a type of data carried by a sub-flow of the application session. In such embodiments, the sub-flow carries one of video data and audio data.

In one embodiment, the first network node configures the RV-QoE information for the UE for the at least part of the application session.

In one embodiment, the first network node sends, to the UE, an indication for the UE to transmit RVQoE reports comprising one or more RVQoE parameters to the second network node.

In one embodiment, at least one RVQoE parameter included in the RVQoE reports to be transmitted by the UE to the second network node is different than the RVQoE parameters included in the RVQoE reports currently being sent by the UE.

In one embodiment, the RVQoE parameters comprise RVQoE measurement results.

In one embodiment, the one or more RVQoE parameters to be transmitted by the UE to the second network node are negotiated between the first and second network nodes.

In another embodiment, the first network node sends a request to the second network node to reconfigure the RVQoE measurements for the UE.

In one embodiment, the first network node receives a request from the second network node to reconfigure the RVQoE measurements for the UE, the request comprising a RVQoE measurement reconfiguration for the UE.

In such embodiment, the indication sent to the UE to transmit the RVQoE reports to the second network node comprises the RVQoE measurement reconfiguration received from the second network node.

FIG. 8 is a flow diagram illustrating a method 140 for multi-connectivity operation for a User Equipment (UE) in a communications system comprising first and second network nodes. In this embodiment, the first and second network nodes are involved in the multi-connectivity operation of the UE and the method 140 is implemented at the second network node.

As seen in FIG. 8, the second network node receives an indication from the first network node to configure Radio Access Network (RAN) Visible Quality of Experience (RV-QoE) information for UE 24 for at least part of the application session (box 142). So received, the second network node sends a response message to the first network node that indicates whether the second network node will configure the RVQoE information for the UE (box 144).

In one embodiment, the response message to the first network node is an acknowledgement indicating that the second network node will configure the RVQoE information for the UE. In such embodiments, the second network node can configure RVQoE measurements at the UE, or the second network node can modify an existing RVQoE configuration at the UE.

In another embodiment, the response message to the first network node is a rejection indicating that the second network node will not configure the RVQoE information for the UE. In these embodiments, the second network node can then either send, or refrain from sending, an indication of a preferred RVQoE configuration to the first network node with the response message.

In one embodiment, after sending the response message indicating the rejection to the first network node, the second network node sends an Initiate Coordination Procedure message to the first network node to begin receiving RVQoE reports from the UE.

In these embodiments, the second network node sends an indication of a change in a RVQoE configuration of the UE to the first network node.

In one or more embodiments, the second network node receives RVQoE reports from the UE.

In one embodiment, the second network node receives, from the first network node, an indication identifying a type of data carried by a sub-flow of the application session.

In one embodiment, the second network node sends, to the UE, an indication for the UE to transmit RVQoE reports to the first network node.

In one embodiment, at least one parameter included in the RVQoE reports to be transmitted by the UE to the first network node is different than parameters included in the RVQoE reports currently being transmitted by the UE.

In one embodiment, the RVQoE parameters comprise RVQoE measurement results.

In one embodiment, the one or more RVQoE parameters to be transmitted by the UE to the first network node are negotiated between the first and second network nodes.

In one embodiment, the second network node sends a request to the first network node to reconfigure the RVQoE measurements for the UE.

In another embodiment, the second network node receives a request from the first network node to reconfigure the RVQoE measurements for the UE, the request comprising a RVQoE measurement reconfiguration for the UE.

In one embodiment, the indication sent to the UE to transmit the RVQoE reports to the first network node comprises the RVQoE measurement reconfiguration received from the first network node.

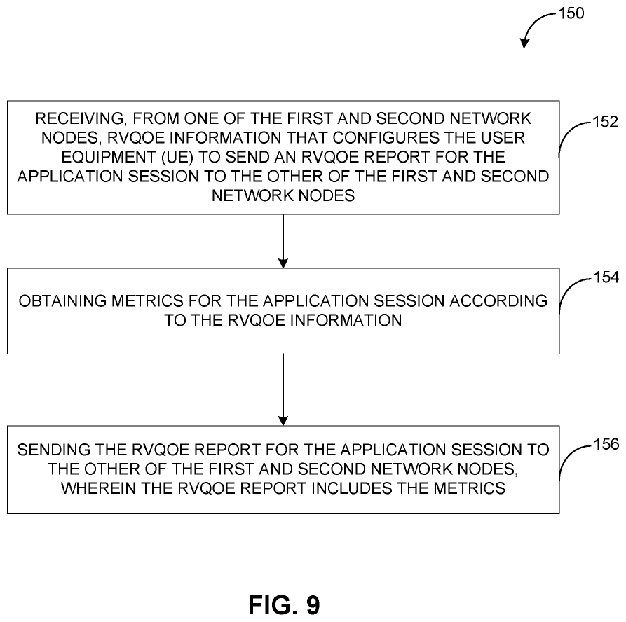

FIG. 9 is a flow diagram illustrating a method 150, implemented at UE 24, for multi-connectivity operation for a User Equipment (UE) in a communications system comprising first and second network nodes (i.e., MN 20 and SN 22). In this embodiment, the first and second network nodes are involved in the multi-connectivity operation of the UE, and the UE is configured to send Radio Access Network (RAN) Visible Quality of Experience (RV-QoE) reports for an application session to the first network node.

As seen in FIG. 9, UE 24 receives, from one of the first and second network nodes, RVQoE information that configures UE 24 to send an RVQoE report for the application session to the other of the first and second network nodes (box 152). Responsive to receiving the RVQoE information, UE 24 obtains metrics for the application session according to the RVQoE information (box 154) and sends the RVQoE report for the application session to the other of the first and second network nodes (box 156). The RVQoE report includes the metrics obtained by UE 24.

In one embodiment, responsive to receiving the RVQoE information, the UE reconfigures its operating mode to a multi-connectivity mode.

In one embodiment, responsive to receiving the RVQoE information, the UE reconfigures an operating mode of the UE to a single-connectivity mode.

In one embodiment, the UE receives, from the one of the first and second network nodes, an indication to begin transmitting RVQoE reports to the other of the first and second network nodes.

In one embodiment, at least one parameter included in the RVQoE reports to be transmitted by the UE to the other of the first and second network nodes is different than parameters included in the RVQoE reports currently being transmitted by the UE.

In one embodiment, the RVQoE parameters comprise RVQoE measurement results.

In one embodiment, the indication to transmit the RVQoE reports to the other of the first and second network nodes comprises a RVQoE measurement reconfiguration.

In any of the embodiments shown in FIGS. 7-9, the first network node is a Master Node (MN), and the second network node is a Secondary Node (SN).

Similarly, in any of the embodiments shown in FIGS. 7-9, the first network node is a Secondary Node (SN), and the second network node is a Master Node (MN).

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessors or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

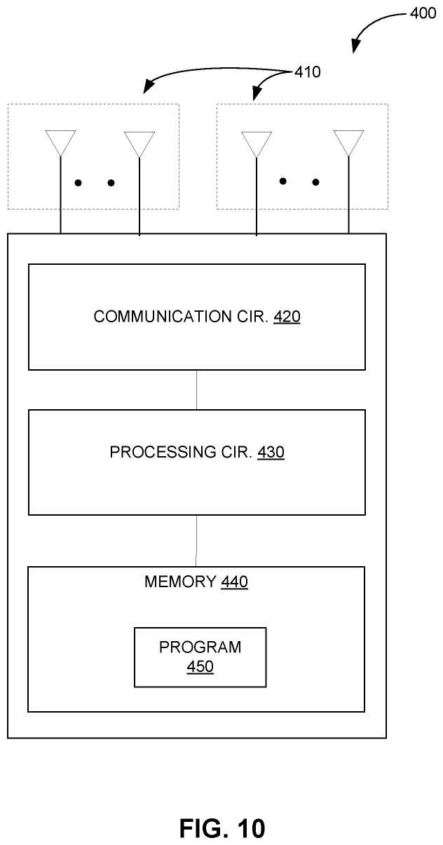

FIG. 10 illustrates the main functional components of a UE 400. The UE 400 includes an antenna panel or antenna array comprising a plurality of antennas 410, communication circuitry 420, processing circuitry 430, and memory 440.

The communication circuitry 420 connects to the antennas 410 and comprises radio frequency (RF) circuitry 422 for communicating over a wireless communication link with multiple TRPs in a wireless communication system. The RF circuitry may comprise, for example, a transmitter and receiver configured to operate according to the 5G standards or other wireless communication standard. In exemplary embodiments, the RF circuitry includes two or more receiver chains for receiving signals transmitted from spatially separated TRPs.

The processing circuitry 430 comprises one or more microprocessors, hardware, firmware, or a combination thereof that controls the overall operation of the UE 400. The processing circuitry 430 can be configured by software to perform the methods herein described including the method 150 shown in FIG. 9.

Memory 440 comprises both volatile and non-volatile memory for storing computer program code and data needed by the processing circuitry 430 for operation. Memory 440 may comprise any tangible, non-transitory computer-readable storage medium for storing data including electronic, magnetic, optical, electromagnetic, or semiconductor data storage. Memory 440 stores a computer program 450 comprising executable instructions that configure the processing circuit 430 in the UE 400 to perform the methods herein described including the method 150 shown in FIG. 9. A computer program 450 in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 450 for configuring the processing circuitry 430 as herein described may be stored in a removable memory, such as a portable compact disc, portable digital video disc, or other removable media. The computer program 450 may also be embodied in a carrier such as an electronic signal, optical signal, radio signal, or computer readable storage medium.

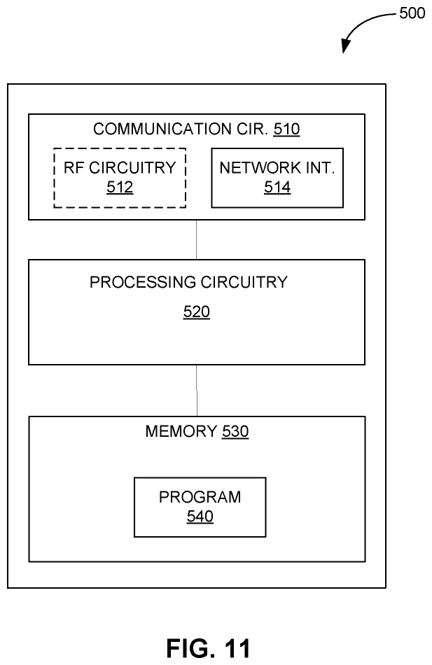

FIG. 11 illustrates the main functional components of a network node 500 (e.g., MN 20 and/or SN 22), which by way of example, may comprise a base station (BS), distributed unit (DU), centralized unit (CU), or other RAN node. The RAN node 500 comprises communication circuitry 510, processing circuitry 520, and memory 530.

In some embodiments, the communication circuitry 510 comprises both radio frequency (RF) circuitry 512 and network interface circuitry (NIC) 514. In other embodiments, however, the network node may comprise only NIC 514. More particularly, the RF circuitry 512 can be located at one or more TRPs and comprises the RF components necessary for communicating with UEs over a wireless communication link. According to the present embodiments, the RF circuitry 512 may comprise, for example, a transmitter and receiver configured to operate according to the 5G standards or other wireless communication standard.

The communication circuitry 510 comprises network interface circuitry (e.g., NIC 514) for communication with other RAN nodes, core network nodes, and or external systems. The network interface circuitry may, for example, comprise an Ethernet interface, optical network interface, or a wireless interface.

The processing circuitry 520 comprises one or more microprocessors, hardware, firmware, or a combination thereof that controls the overall operation of the RAN node 500. The processing circuitry 520 can be configured by software to perform one or more of the methods herein described including the methods 130, 140 as shown in FIGS. 7 and 8.

Memory 530 comprises both volatile and non-volatile memory for storing computer program code and data needed by the processing circuitry 520 for operation. Memory 530 may comprise any tangible, non-transitory computer-readable storage medium for storing data including electronic, magnetic, optical, electromagnetic, or semiconductor data storage. Memory 530 stores a computer program 540 comprising executable instructions that configure the processing circuit 520 in the network node 500 to perform one or more of the methods herein described including the methods 130, 140 as shown in FIGS. 7 and 8, respectively. A computer program 540 in this regard may comprise one or more code modules corresponding to the means or units described above.

In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 550 for configuring the processing circuitry 520 as herein described may be stored in a removable memory, such as a portable compact disc, portable digital video disc, or other removable media. The computer program 540 may also be embodied in a carrier such as an electronic signal, optical signal, radio signal, or computer readable storage medium.

Those skilled in the art will also appreciate that embodiments herein further include corresponding computer programs. A computer program-comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

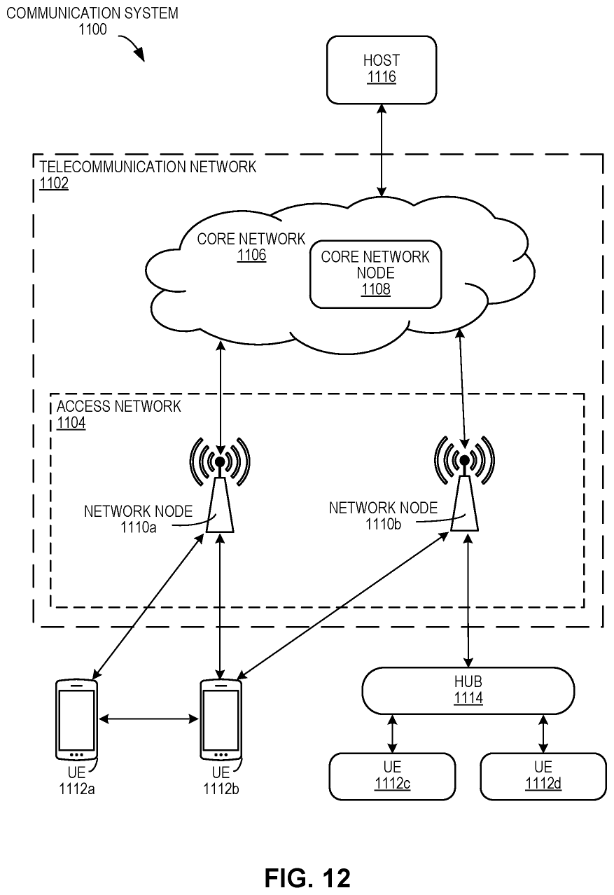

FIG. 12 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3rd Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102 and may be operated by the service provider or on behalf of the service provider. The host 1116 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular, if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

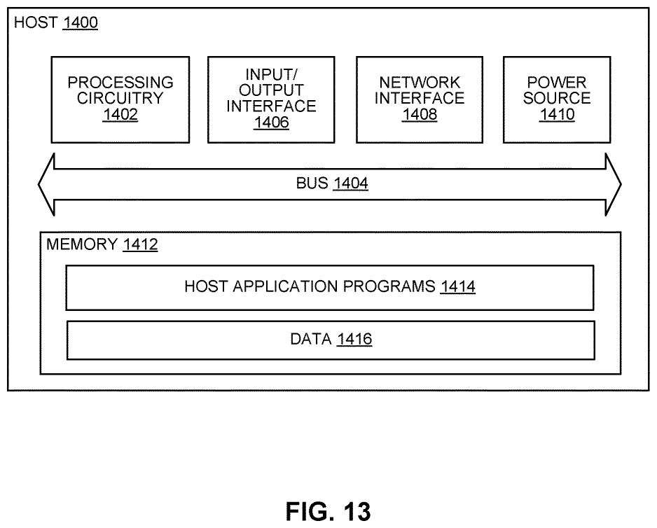

FIG. 13 is a block diagram of a host 1400, which may be an embodiment of the host 1116 of FIG. 12, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

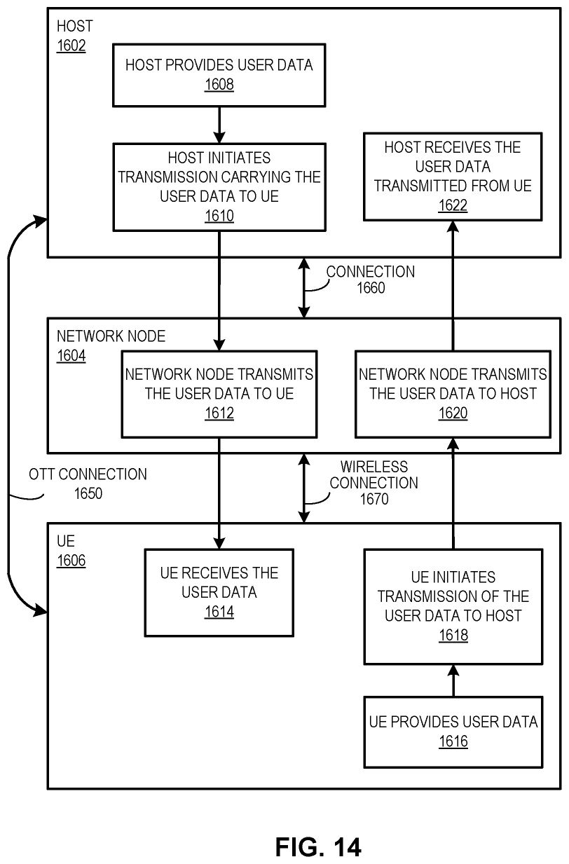

FIG. 14 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 12), network node (such as network node 1110a of FIG. 12), and host (such as host 1116 of FIG. 12) discussed in the preceding paragraphs will now be described with reference to FIG. 14.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 10) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may enable the UE to adapt faster to radio conditions and realize higher data throughput. In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

The present embodiments may, of course, be carried out in other ways than those specifically set forth herein without departing from characteristics described herein. The present embodiments are therefore to be considered in all respects as illustrative and not restrictive, and all changes coming within the meaning and equivalency range of the appended claims are intended to be embraced therein.

1-73. (canceled)

74. A method for multi-connectivity operation for a User Equipment (UE) in a communications system comprising first and second network nodes, wherein the first and second network nodes are involved in the multi-connectivity operation of the UE, the method implemented at the first network node and comprising:
determining that the second network node is to carry at least part of an application session for the UE; and
responsive to the determining, sending an indication to the second network node causing the second network node to configure Radio Access Network (RAN) Visible Quality of Experience (RV-QoE) information for the UE for the at least part of the application session.

75. The method of claim 74, wherein the first network node determines that the application session for which the RVQoE measurements are configured will be carried by the second network node.

76. The method of claim 74, wherein determining that the second network node is to carry at least part of an application session for the UE is based on a switch of the path used to deliver a data flow of the application session.

77. The method of claim 74, wherein determining that the second network node is to carry at least part of an application session for the UE is based on a decision to duplicate a data flow of the application session and to deliver the duplicate data flow via both the first network node and the second network node.

78. The method of claim 74, further comprising the first network node sending one or more indications for RVQoE configuration coordination to the second network node.

79. The method of claim 78, further comprising the first network node receiving a rejection from the second network node responsive to the one or more indications for RVQoE configuration coordination.

80. The method of claim 74, further comprising the first network node sending an indication to transmit RVQoE reports to the second network node.

81. The method of claim 80, wherein the first network node receives an indication of a preferred RVQoE configuration for the second network node with the rejection.

82. The method of claim 74, wherein the first network node configures the RV-QoE information for the UE for the at least part of the application session.

83. A method for multi-connectivity operation for a User Equipment (UE) in a communications system comprising first and second network nodes, wherein the first and second network nodes are involved in the multi-connectivity operation of the UE, the method implemented at the second network node and comprising:
receiving an indication from the first network node to configure Radio Access Network (RAN) Visible Quality of Experience (RV-QoE) information for the UE for at least part of the application session; and
sending a response message to the first network node, wherein the response message indicates whether the second network node will configure the RVQoE information for the UE.

84. The method of claim 83, wherein the response message to the first network node is a rejection indicating that the second network node will not configure the RVQoE information for the UE.

85. The method of claim 84, wherein after sending the response message indicating the rejection to the first network node, the method further comprises the second network node sending an Initiate Coordination Procedure message to the first network node to begin receiving RVQoE reports from the UE.

86. The method of claim 84, further comprising sending an indication of a preferred RVQoE configuration to the first network node with the response message.

87. The method of claim 84, further comprising sending to the first network node an indication of a change in a RVQoE configuration of the UE.

88. The method of claim 83, further comprising receiving RVQoE reports from the UE.

89. The method of claim 83, further comprising sending, to the UE, an indication for the UE to transmit RVQoE reports to the first network node.

90. The method of claim 89, wherein the second network node receives a request from the first network node to reconfigure the RVQoE measurements for the UE, the request comprising a RVQoE measurement reconfiguration for the UE.

91. The method of claim 90, wherein the indication sent to the UE to transmit the RVQoE reports to the first network node comprises the RVQoE measurement reconfiguration received from the first network node.

92. A first network node for multi-connectivity operation for a User Equipment (UE) in a communications system comprising the first network node and a second network node, wherein the first and second network nodes are involved in the multi-connectivity operation of the UE, the first network node being configured to:
determine that the second network node is to carry at least part of an application session for a UE; and
responsive to the determining, send an indication to the second network node causing the second network node to configure Radio Access Network (RAN) Visible Quality of Experience (RV-QoE) information for the UE for the at least part of the application session.

93. A second network node for multi-connectivity operation for a User Equipment (UE) in a communications system comprising a first network node and the second network node, wherein the first and second network nodes are involved in the multi-connectivity operation of the UE, the second network node being configured to:
receive an indication from the first network node to configure Radio Access Network (RAN) Visible Quality of Experience (RV-QoE) information for the UE for at least part of the application session; and
send a response message to the first network node, wherein the response message indicates whether the second network node will configure the RVQoE information for the UE.
